(19) United States
(12) Patent Application Publication
(10) Pub. No.: US 2016/0272114 A1
(43) Pub. Date: Sep. 22, 2016

(54) (MACSS SYSTEM) MEDINA ALERT CHILD SAFETY SYSTEM

(71) Applicant: David Larry Medina, San Antonio, TX (US)

(72) Inventor: David Larry Medina, San Antonio, TX (US)

(21) Appl. No.: 14/747,059

(22) Filed: Jun. 23, 2015

Related U.S. Application Data
(60) Provisional application No. 61/998,324, filed on Jun. 24, 2014.

(51) Int. Cl. B60Q 9/00; G01S 19/13; B62D 25/08; B60J 1/17; E05F 15/71

(52) U.S. Cl. CPC B60Q 9/00; B60J 1/17; E05F 15/71; B62D 25/087; G01S 19/13

(57) ABSTRACT

The Present Invention is to save lives of children, and seniors that might be left in a hot car. The Present Invention will be activated, when temperatures reach dangerous levels. The EKG Sensors, Motion detectors and heat sensitive readers will automatically lower all windows, and sound a siren, “baby left in hot car,” exterior stroke light will come. The Present Invention will also call and give GPS Coordinates to first responders such as Police, Paramedics, Fire Department, parents of child, children of elderly parents that have Alzheimer's and five other important phone numbers programmed into car system. The system will call out through On Star or similar systems that are in vehicles today. This system also works in the trunk area if a child makes their way through the back seat into the trunk, or if a person gets locked in a trunk, playing or unwillingly kidnapped.

### BACKGROUND OF THE INVENTION

The Present invention is related to the field of child, senior citizens and pet safety. Children are injured through heat exhaustion and sometimes die when left inside a hot car. Also senior citizens that could have a diabetic stroke, pass out or Alzheimer's and forget to turn on the air condition or lower windows in their hot car. Also dogs, cats or other animals could also be forgotten in a hot car. Sometimes it is too late to revive a heart beat in a child or senior.

### SUMMARY OF THE INVENTION

The present Invention is directed to a system that warns a parent, Police, EMS, Fire Department, Child Protective Services, and five family members or friends that a child or senior has been left in a hot car with dangerous temperature readings. The system is automatically activated and windows are automatically lowered, trunk opens, in case a child has made its way to the trunk from the back seat. EKG sensors, motion sensors, voice listening sensors go into effect instantly to trigger safety systems sensors, also stroke lights, and voice siren will kick in saying child in hot car, also GPS location will be sent to first responders instantly through On Star, Low Jack or similar systems.

### DETAILED DESCRIPTION OF INVENTION

The Present Invention is to save lives of children, seniors, and people that might have a diabetic seizure, heart attack, stroke, or even an animal that is left in a car to prevent a heat stroke. If a child is left in a car or truck accidently, temperatures start rising. The parent is at work now and forgot to drop their child at daycare due to the distractions of cell phone calls, texting, and music. The child is forgotten in a hot car until after work and usually it is too late by then. The way my Invention works is that the car is equipped with similar to EKG Sensors that are placed under upholstery seat material of front and back seats. Sensors will fill light sensitive body movement and a voice crying or moaning voice receiving sensors and automobile voice microphone, similar to a hands free cell phone device that will activate when temperature reaches dangerous heat levels. There will also be motion sensors on the rear view mirror scanning motion of people or animals. It will activate after 76 degrees and hotter. Windows would have to be closed or nearly closed before activation occurs. All of these sensors will also be installed inside trunk area for accidental lock in or kidnapping, when system is triggered and activated when child is left in hot car, windows will automatically lower through self-opening system that reads temperatures, heart beat and motion. Trunk will also unlock and open and siren will activate and sound loud enough to be heard up to 300 yards or more, lights will begin flashing with siren for people to hear, “Baby in hot car,” and see and respond to child. It will automatically dial all to First Responders like Police, Paramedics, Fire Department, Park Police, local Constables, and Child Protective Services through GPS of similar systems. At the same time it will call the parent of the child on their phone and five important relatives or friends. That is how the MACSS System works that I David Larry Medina have invented. Medina Alert Child Safety System.

### DETAILED DESCRIPTION OF THE PREFERRED EMBODIMENT

The Alert Child Safety System of the present invention will now be described in detail by reference to specific figures, however this detailed description should not be interpreted as limiting the principles of the invention.

The present invention shows Alert Child Safety System that relates to a seat (10) in a vehicle, elements are listed below. FIG. 1 is a view of the present invention that demonstrates examples on how the Child Alert Safety System works. The EKG sensors are located inside the seat upholstery (12).

When the Alert Child Safety System (10) is activated threw EKG sensors (14) triggers a lowering of car windows while vehicle ignition is off.

When the Alert Child Safety System (10) is activated the vehicles computer system (16) dials family and friends phone numbers which are programmed in vehicles computer dialing system, message will read “baby left in hot car.” (10) Will also trigger (16) communication contact to first responders, 911, police, fire, EMS, and give GPS location.

When the Alert Child Safety System (10) can also be activated threw motion sensors (18) that is located on the rear view mirror and headliner light.

When the Alert Child Safety System (10) is activated a siren alarm (20) will activate and repeat,

“Help Baby,” located under hood.

When the Alert Child Safety System (10) is activated a front stroke light (22) that is located above a rear view mirror will flash repeatedly. And secondary stroke light (24) which is located on third brake light will also be activated. There is also a microphone (26) inside vehicle which can record moaning voice to trigger Alert Child Safety System (10).

The trunk area (26) will be equipped with sensors that will activate The Alert Child Safety System, if a child had made its way into the trunk from the back seat area threw open passages, a kid napped person, or a pet will also activate safety system when temperature reaches dangerous levels, trunk will automatically open.

### BRIEF DESCRIPTION OF THE DRAWING

FIG. 1 Shows the side view of a automobile specially equipped and designed in conjunction with 10, 12, 14, 16, 18, 20, 22, 24, 26, according to one embodiment Of the present invention.

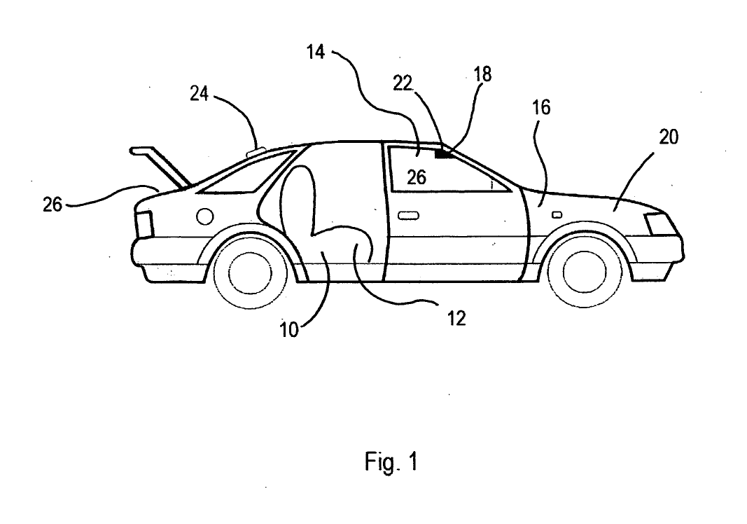

I claim:

1. Computer system located in vehicle that triggers many safety features through heat temperature activation 68 degrees or hotter.

2. When system is triggered through heat, windows will immediately lower and open to allow air into vehicle and heat out to possibly save a life of a child, senior citizen or pet.

3. Sensor in truck area will sense movement, motion or voice.

4. Trunk lid immediately opens to save child, in trunk kidnapped person or pet.

5. GPS location will be given to First Responders, Family Members and friends that are listed for emergency call out for child or senior citizen left in hot car.

6. EKG like sensors are beneath seat upholstery material.

7. Siren alarm under hood will sound out loud “Child Left in Hot Car.”

8. Motion sensor on rear view mirror inside car to sense movement if temperature rises beyond 63 degrees or hotter.

9. Microphone inside car to hear child crying, Senior citizen confused or dog barking if temperature gets too hot if windows are closed or slightly opened, will trigger the computer system and all the safety functions to go into effect.

10. The back stroke light connected with third brake light will trigger light so people can see and get their attention.

11. Back stroke light to attract attention when triggered by child safety system.

12. Front stroke light to attract attention when triggered by child safety system.

13. Sensitive Sensor readers will be inserted in the upholstery welt on seats under where knees bend to receive pulse readings for system to be triggered in a hot car.
